(19) United States
(12) Patent Application Publication
(10) Pub. No.: US 2024/0367458 A1
(43) Pub. Date: Nov. 7, 2024

(54) CHALK LINE HOUSING WITH CARTRIDGE TEAR MOUNT

(71) Applicant: Klein Tools, Inc., Lincolnshire, IL (US)

(72) Inventors: Shane Matthew Wilson, Waxahachie, TX (US); Eric Cheung, Burleson, TX (US); Adriana Facchina, Fort Worth, TX (US)

(73) Assignee: Klein Tools, Inc., Lincolnshire, IL (US)

(21) Appl. No.: 18/141,513

(22) Filed: May 1, 2023

(51) Int. Cl. B44D 3/38

(52) U.S. Cl. CPC B44D 3/38

(57) ABSTRACT

A chalk line reel system includes a chalk cartridge having a cartridge housing including a chalk compartment at least partially filled with chalk and a chalk dispensing opening to the chalk compartment. The chalk cartridge has a frangible seal closing the chalk dispensing opening. The chalk line reel system includes a chalk line housing having an interior space, a mount structure for releasably mounting the chalk cartridge, and a seal breaking structure configured to break the frangible seal to allow chalk to be dispensed from the chalk compartment into the interior space with the chalk cartridge engaged in the mount structure. The chalk line reel system includes a reel mounted to the housing for rotation relative to the housing about a reel axis, and a chalk line wound around the reel and engageable with chalk contained in the interior space.

### BACKGROUND OF THE DISCLOSURE

The present disclosure relates to chalk line reel systems, and more specifically, chalk line reel systems having a replaceable chalk cartridge. A chalk line, also known as a chalk box or chalk reel, is used for making straight lines on surfaces. Chalk lines typically include a reel or spool holding a line (e.g., string, cord) coated in chalk powder or other type of dye. The line, when pulled taut against a surface, and then snapped, leaves a straight line of chalk or dye to serve as a guide.

Conventional chalk lines commonly have an interior space holding chalk therein. Some conventional chalk lines require partial disassembly to refill the chalk line or may include openings to the interior space for a user to refill the chalk. A squeeze bottle filled with chalk is often used to refill these conventional chalk lines. This process is often both messy and time-consuming. It is desirable to provide a chalk line reel system that allows a user to quickly and easily refill or replace the chalk in a chalk reel without the mess and hassle of a conventional system. Such a system will improve ease of use and increase functionality over a conventional chalk line.

### BRIEF SUMMARY OF THE DISCLOSURE

In accordance with one feature of this disclosure, a chalk line reel system is provided. The chalk line reel system includes a chalk cartridge having a cartridge housing including a chalk compartment at least partially filled with chalk and a chalk dispensing opening to the chalk compartment. The chalk cartridge has a frangible seal closing the chalk dispensing opening. The chalk line reel system includes a chalk line housing having an interior space, a mount structure for releasably mounting the chalk cartridge, and a seal breaking structure configured to break the frangible seal to allow chalk to be dispensed from the chalk compartment into the interior space with the chalk cartridge engaged in the mount structure. The chalk line reel system includes a reel mounted to the housing for rotation relative to the housing about a reel axis, and a chalk line wound around the reel and engageable with chalk contained in the interior space.

In one feature, the seal breaking structure partially removes the frangible seal as the chalk cartridge engages the mount structure.

As one feature, the seal breaking structure perforates the frangible seal as the chalk cartridge engages the mount structure.

In one feature the chalk cartridge further includes a mount receiving structure, defining a sliding axis, configured to slidably engage the mount structure, along the sliding axis, to releasably mount the chalk cartridge. The seal breaking structure perforates the frangible seal as the mount receiving structure slidably engages the mount structure.

As one feature, the frangible seal and the chalk dispensing opening form an acute angle relative to the sliding axis.

In another feature, the seal breaking structure includes a plurality of teeth.

According to one feature, the seal breaking structure includes a cutting blade.

In yet a further feature, the chalk line reel system includes a manually operated crank arm operably connected to the rotatable reel to allow a user to manually rotate the reel.

In another feature, the chalk line reel system includes a spring operably connected to the gear system to rotate the reel.

In one feature, the frangible seal includes a foil portion induction sealed to an edge of the chalk dispensing opening.

As one feature, the interior space includes a first interior space and a second interior space. The reel is mounted to the housing in the first interior space, the chalk is contained in the second interior space, and the chalk line housing further includes a fibrous material, between the first interior space and the second interior space, limiting passage of chalk between the first interior space and the second interior space.

In accordance with one feature of this disclosure, a chalk line reel is provided. The chalk line reel includes a chalk line housing having an interior space, a mount structure for releasably mounting a chalk cartridge, and a seal breaking structure configured to break a frangible sea of the chalk cartridge to allow chalk to be dispensed from the chalk cartridge into the interior space with the chalk cartridge engaged in the mount structure. The chalk line reel includes a reel mounted to the housing for rotation relative to the housing about a reel axis, and a chalk line wound around the reel and engageable with chalk contained in the interior space.

As one feature, the seal breaking structure is configured to partially remove a frangible seal of the chalk cartridge as the chalk cartridge engages the mount structure.

In one feature, the seal breaking structure is configured to perforate a frangible seal of the chalk cartridge as the chalk cartridge engages the mount structure.

In another feature, the seal breaking structure includes a plurality of teeth.

As one feature, the seal breaking structure includes a cutting blade.

In another feature, the chalk line reel includes a manually operated crank arm operably connected to the rotatable reel to allow a user to manually rotate the reel.

In another feature, the chalk line reel system includes a spring operably connected to the gear system to rotate the reel.

According to one feature, the interior space includes a first interior space and a second interior space. The reel is mounted to the housing in the first interior space, the chalk is contained in the second interior space, and the chalk line housing further includes a fibrous material, between the first interior space and the second interior space, limiting passage of chalk between the first interior space and the second interior space.

In accordance with one feature of this disclosure, a chalk cartridge for use with a chalk line reel is provided. The chalk cartridge includes a cartridge housing having a chalk compartment at least partially filled with chalk and a chalk dispensing opening, mount receiving structure, defining a sliding axis, configured to slidably engage the chalk line reel, along the sliding axis, to releasably mount the chalk cartridge to the chalk line reel, and a frangible seal closing the chalk dispensing opening. The frangible seal and the chalk dispensing opening form an acute angle relative to the sliding axis.

As one feature, the chalk cartridge includes mount receiving structure, defining a sliding axis, to releasably mount the chalk cartridge to the chalk line reel.

In another feature, the frangible seal and the chalk dispensing opening form an acute angle relative to the sliding axis.

It should be understood that the inventive concepts disclosed herein do not require each of the features discussed above, may include any combination of the features discussed, and may include features not specifically discussed above.

### BRIEF DESCRIPTION OF THE DRAWINGS

FIG. 1 is a top view of a chalk line reel system including a chalk line cartridge and chalk line housing.

FIG. 2A is side view of the chalk line reel system of FIG. 1.

FIG. 2B is a front view of the chalk line reel system of FIG. 1.

FIG. 3 is a section view taken along line 3-3 in FIG. 2A.

FIG. 4 is a section view taken along line 4-4 in FIG. 2B.

FIG. 5A is a view similar to FIG. 1, but without the chalk line cartridge.

FIG. 5B is a view similar to FIG. 2A, but without the chalk line cartridge.

FIG. 5C is a view similar to FIG. 2B, but without the chalk line cartridge.

FIG. 5D is a view similar to FIG. 4, but without the chalk line cartridge.

FIG. 6A is a view similar to FIG. 1, but with the chalk line cartridge partially removed.

FIG. 6B is a view similar to FIG. 2A, but with the chalk line cartridge partially removed.

FIG. 6C is a view similar to FIG. 2B, but with the chalk line cartridge partially removed.

FIG. 6D is a view similar to FIG. 4, but with the chalk line cartridge partially removed.

FIG. 7A is a top view of the chalk line cartridge of FIG. 1.

FIG. 7B is a side view of the chalk line cartridge of FIG. 7A.

FIG. 7C is a bottom view of the chalk line cartridge of FIG. 7A.

FIC. 7D is a front view of the chalk line cartridge of FIG. 7A.

FIG. 7E is a section view taken along line 7E-7E of FIG. 7D.

FIG. 8A is another side view of the chalk line reel system of FIG. 1.

FIG. 8B is a section view taken along line 8B-8B in FIG. 8A.

### DETAILED DESCRIPTION OF PREFERRED EMBODIMENTS

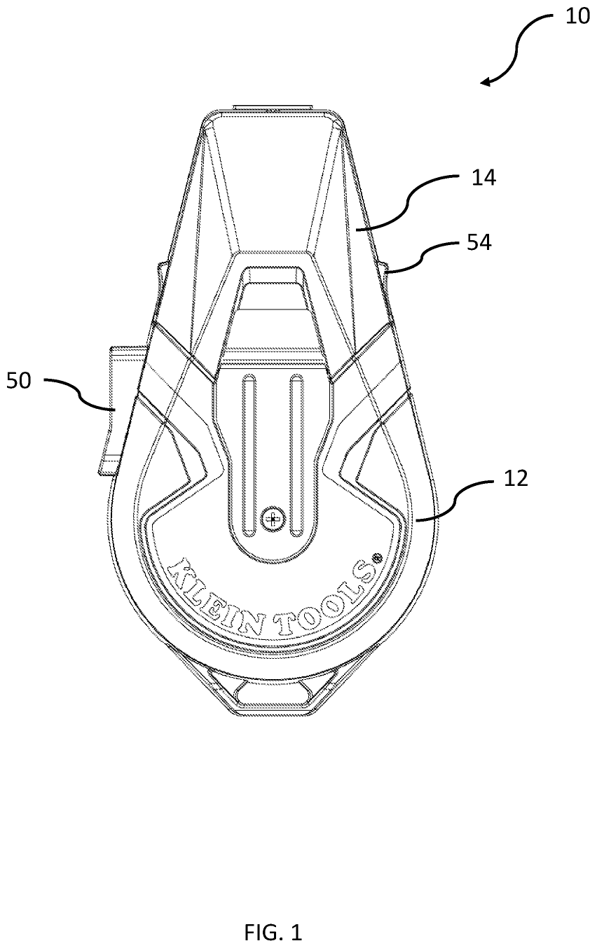

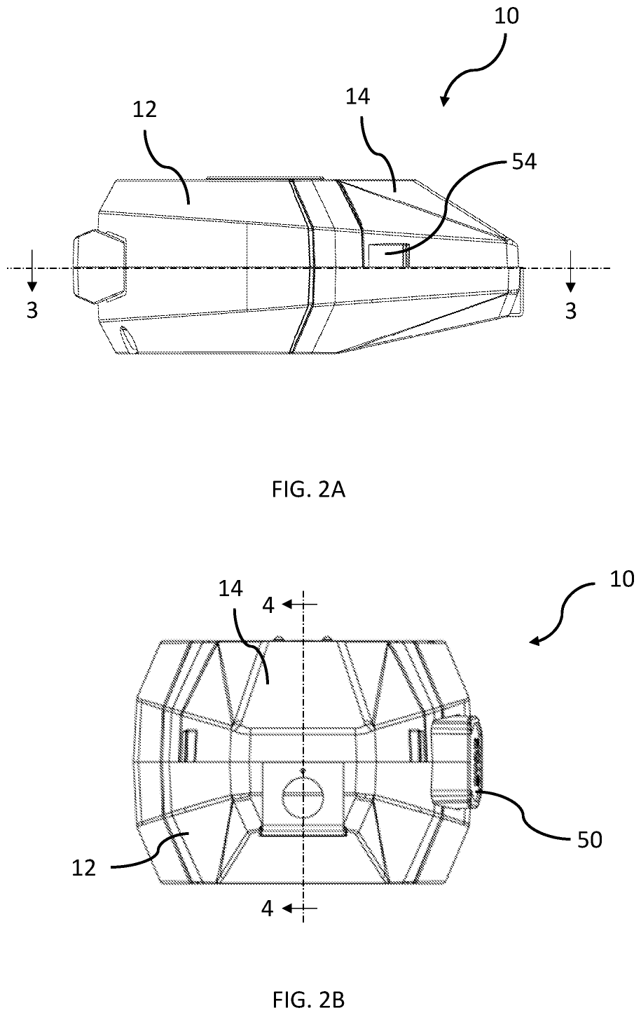

As best seen in FIGS. 1-4, a chalk line reel system 10 is provided for marking chalk lines. In the illustrated and preferred embodiment, the chalk line reel system 10 includes a chalk line housing 12 and a chalk cartridge 14 removably attached thereto. The chalk line housing 12 includes an interior space 16, a mount structure 18, a seal breaking structure 20, a reel 22, and a chalk line 24 (e.g. string). The chalk cartridge 14 includes a cartridge housing 26, a chalk compartment 28, a chalk dispensing opening 30, and a frangible seal 32. The chalk line reel system 10 is configured to at least partially coat the chalk line 24 with chalk when removed from the chalk line housing 12 and allow the chalk line 24 to mark a surface with chalk, for example, by snapping the chalk line 24 against the surface.

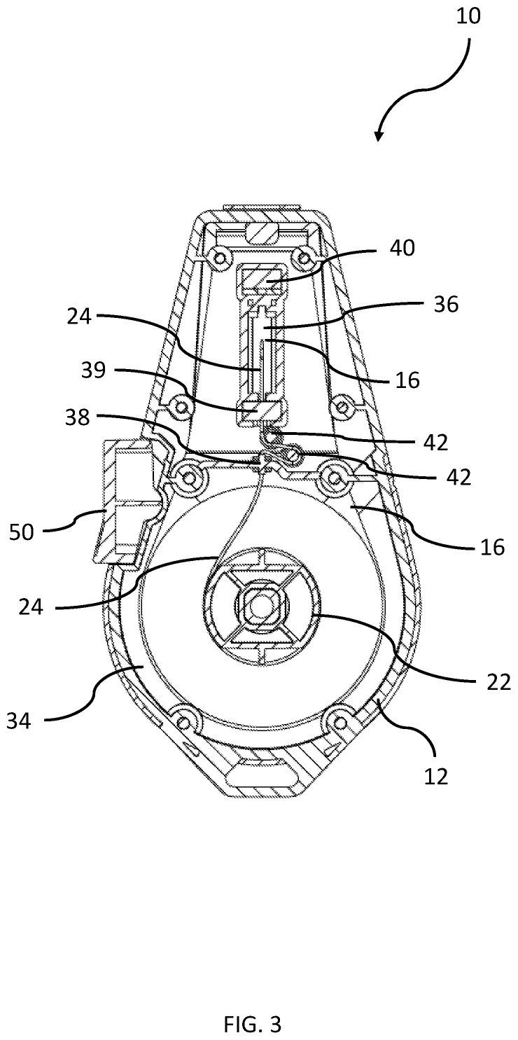

In the illustrated and preferred embodiment, the interior space 16 is formed within the chalk line housing 12 and includes a first interior space 34 and a second interior space 36. The first interior space 34 at least partially encloses the reel 22. The reel 22 is wound with the chalk line 24 and rotates within the first interior space 34 to reel or unreel the chalk line 24 therefrom. The second interior space 36 is configured to hold chalk, received from the chalk cartridge 14, therein. In the illustrated embodiment, the chalk line housing 12 includes a grommet 38 and a first passage 39 (e.g., hole, depression, recess) connecting the second interior space 36 to the first interior space 34. The chalk line housing 12 also includes a second passage 40 exiting the second interior space 36 and out of the chalk line housing 12. The chalk line 24 passes from the first interior space 34 (e.g., from the reel 22) and through the grommet 38 and the first passage 39. The chalk line 24 passes through the second interior space 36, where it is at least partially coated with chalk held therein, and out the second passage 40. In the illustrated and preferred embodiment, the first passage 39 and the second passage 40 include a fibrous material (e.g., wool, cotton, etc.) therein. The fibrous material prevents (e.g., limits) chalk from passing through the first passage 38 or the second passage 40 while allowing the chalk line 24 to pass through the first passage 38 and out the second passage 40 after the chalk line 24 has been coated with chalk. In the illustrated and preferred embodiment, the chalk line housing 12 includes a pair of posts 42 extending from the chalk line housing 12. In the illustrated embodiment, the chalk line 24 wraps around the posts 42, as best shown in FIG. 3, between the grommet 38 and the first passage 39. This prevents, for example, the chalk line 24 from binding on the reel 22 during use by keeping the chalk line 24 taught around the reel 22.

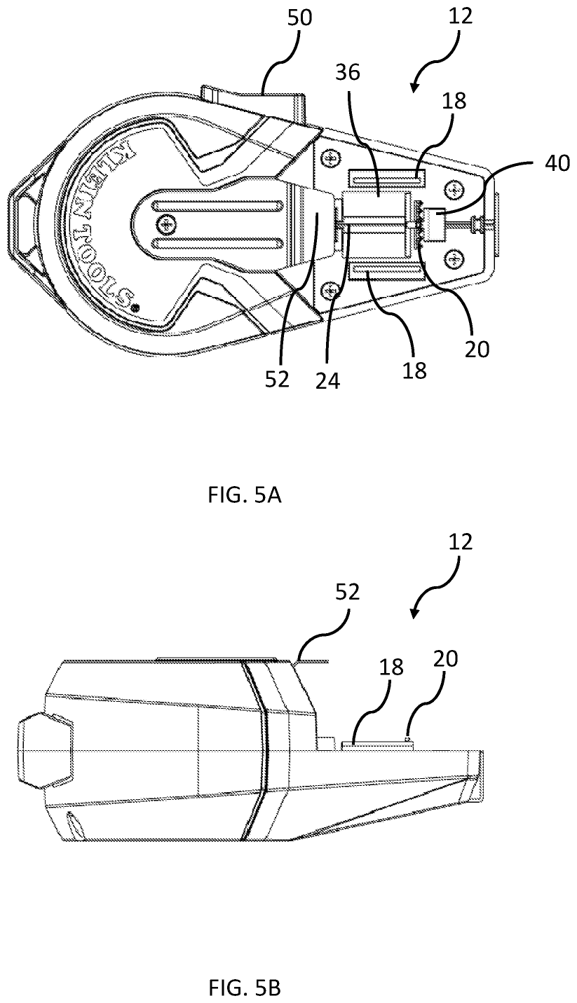

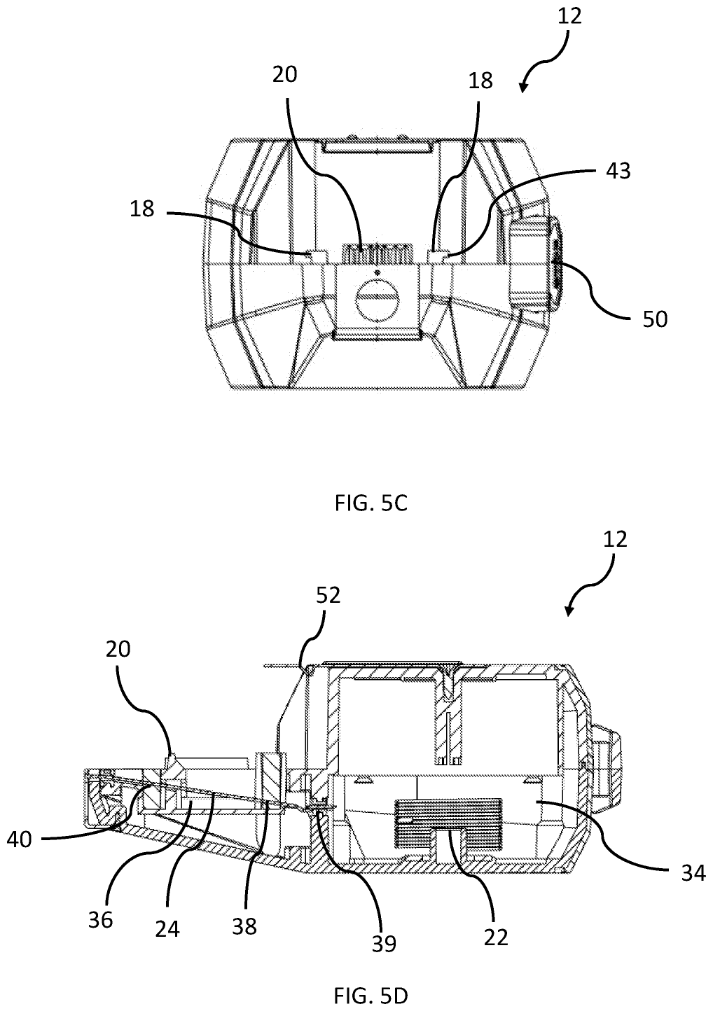

In the illustrated and preferred embodiment, the chalk cartridge 14 is configured to be received by (e.g., slidably attached to) the chalk line housing 12. In the illustrated and preferred embodiment, the mount structure 18 comprises a pair of raised sidewalls (e.g., protruding walls) extending from the chalk line housing, with each sidewall having an outwardly protruding lip 43, as best shown in FIG. 5C. The chalk cartridge 14 includes mount receiving structure 44 corresponding to the mount structure 18. In the illustrated and preferred embodiment, the mount receiving structure 44 comprises a pair of slots, with each slot having a shape corresponding to the sidewalls and protruding lips 43 of the mount structure 18. In the illustrated and preferred embodiment, the mount structures 18 are slidable into the mount receiving structure 44 slots and the mount receiving structure 44 engages the lips 43 to retain the chalk cartridge 14 to the chalk line housing 12.

In the illustrated and preferred embodiment, the chalk compartment 28 comprises an interior space within the cartridge housing 26 of the chalk cartridge 14. The chalk compartment 28 is at least partially filled with chalk (e.g., any marking material as may be used by chalk lines) In some examples, the chalk compartment 28 may include ink. The chalk dispensing opening 30 is open to the chalk compartment 28 and is open to the outside of the chalk cartridge 14 to allow the chalk to pass therethrough (e.g., to the chalk line housing 12 when connected thereto). In the illustrated and preferred embodiment, the chalk dispensing opening 30 includes a frangible seal 32 to seal the chalk dispensing opening 30, for example, to prevent chalk from leaving the chalk compartment 28. In the illustrated and preferred embodiment, the frangible seal 32 comprises a foil seal (e.g., a foil portion) induction sealed to the exterior edges of the chalk dispensing opening 30 to seal the chalk within the chalk compartment 28.

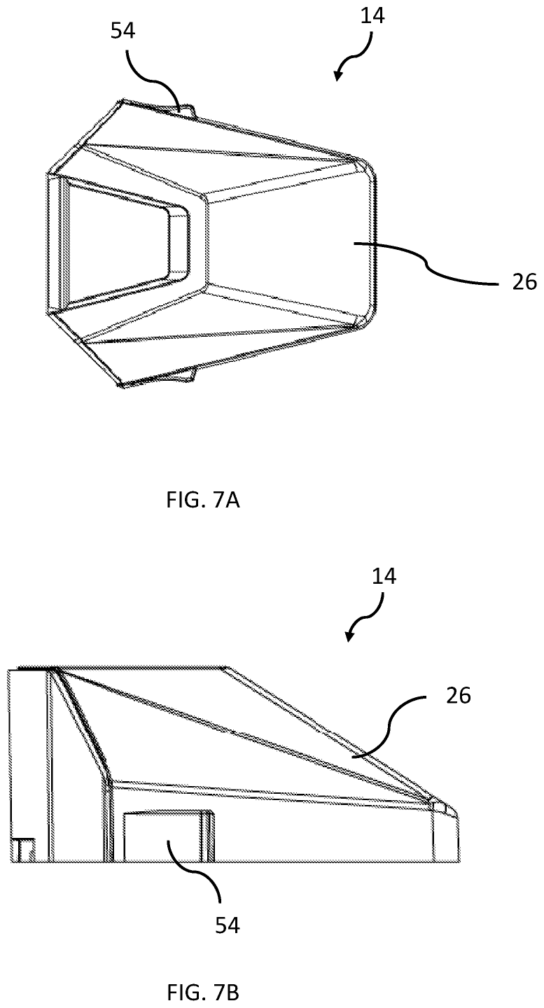

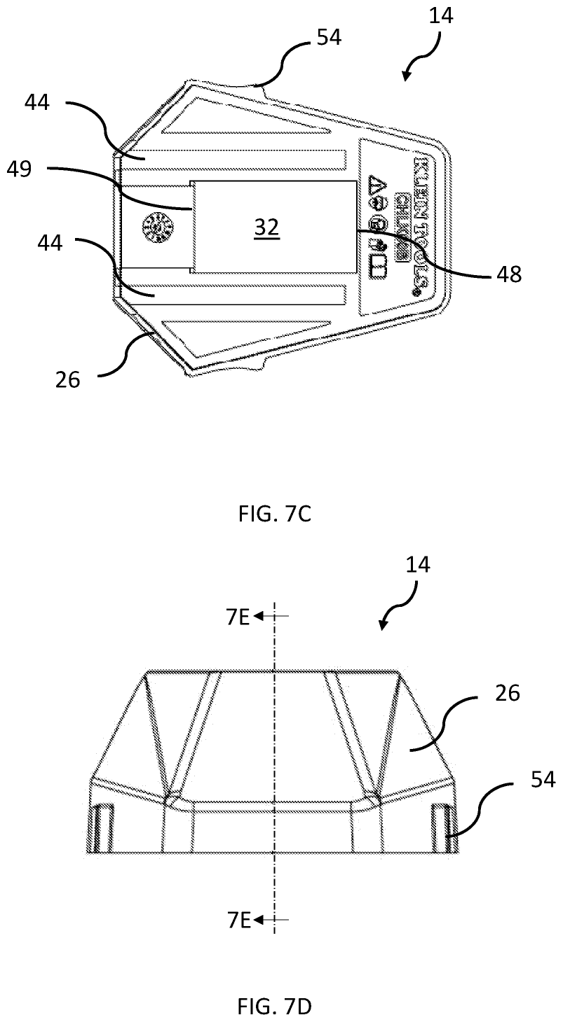

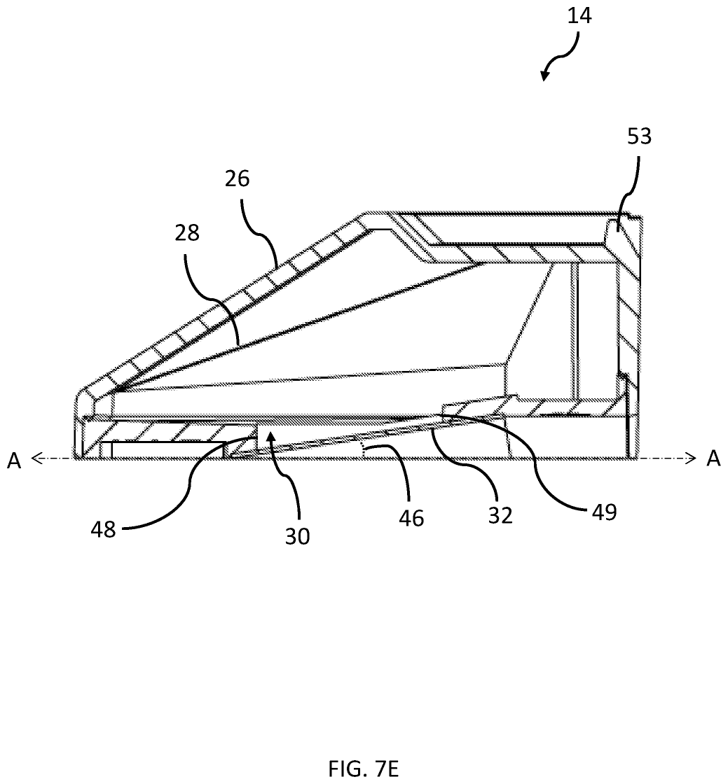

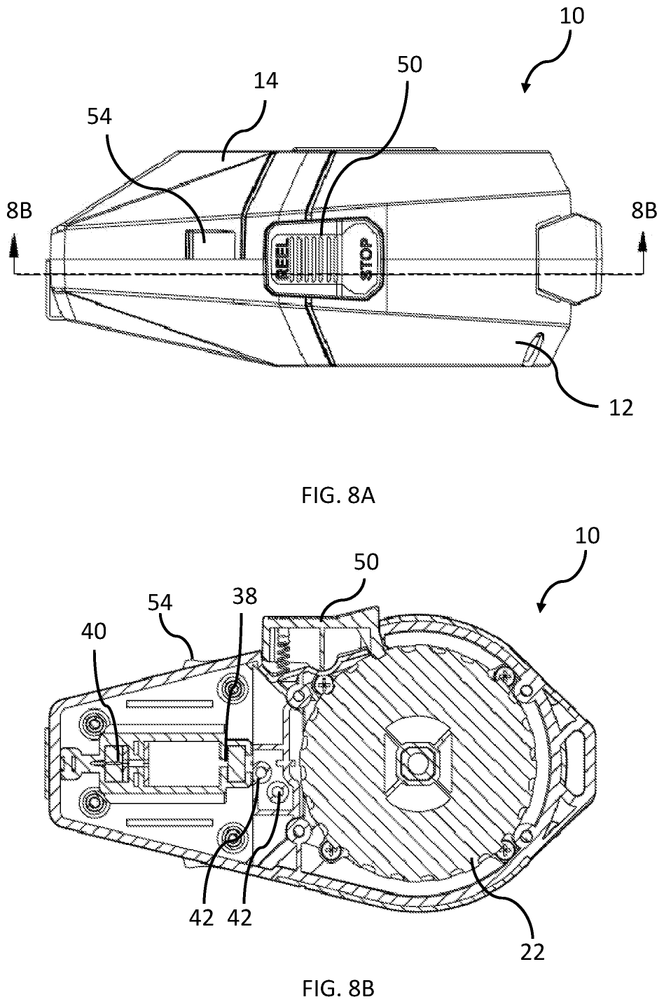

In the illustrated and preferred embodiment, and as best shown in FIG. 7E, the mount receiving structure 44 defines a sliding axis A-A. The sliding axis comprises a plane along which the mount structures 18 may engage and slide along the receiving structures 44. In the illustrated and preferred embodiment, the chalk dispensing opening 30 and the associated frangible seal 32 form an acute angle 46 relative to the sliding axis A-A. For example, with the sliding axis A-A, as shown in FIG. 7E, defining a bottom of the chalk cartridge 14, a front edge 48 of the chalk dispensing opening 30 is closer to the bottom of the chalk cartridge 14 than a back edge 49 of the chalk dispensing opening 30 is to the bottom of the chalk cartridge 14. As will be discussed, the slope of the chalk dispensing opening 30, relative to the sliding axis A-A (e.g., relative to the rest of the chalk cartridge 14) aids in removing the frangible seal 32 from the chalk dispensing opening 30. In the illustrated and preferred embodiment, the front edge 48 is opposite the back edge 49.

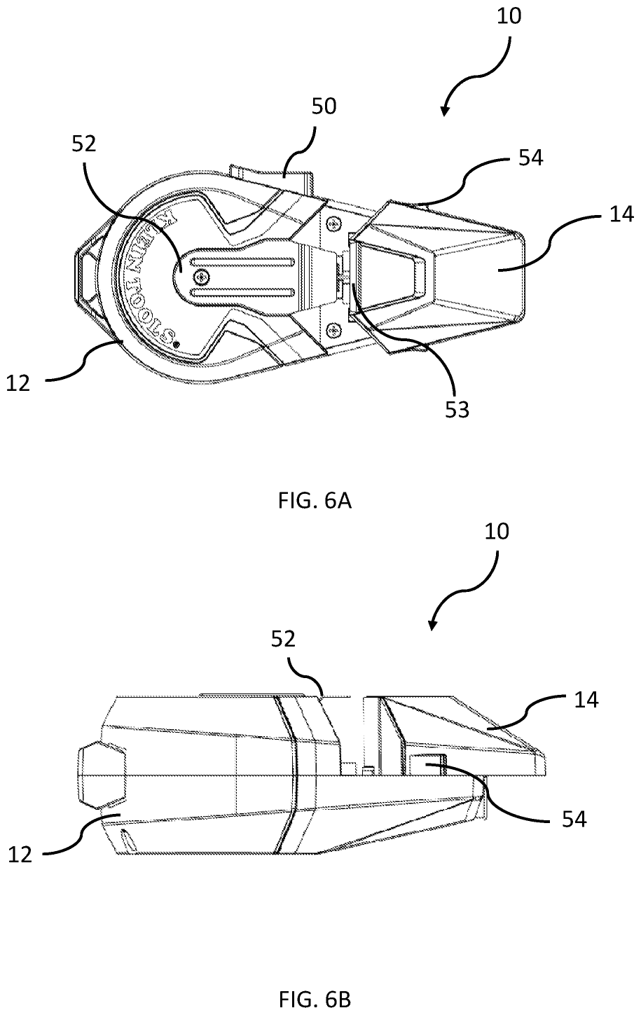

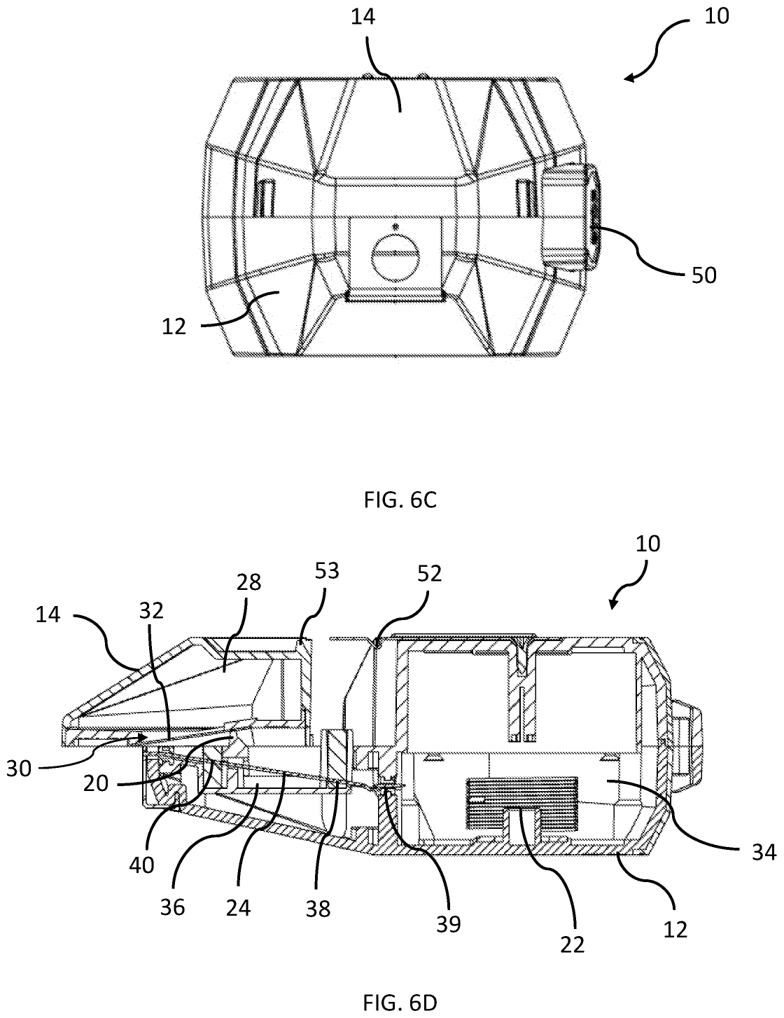

As best shown in FIGS. 5A and 5C, in the illustrated and preferred embodiment, the chalk line housing 12 includes the seal breaking structure 20 next to an opening of the second interior space 36. In the illustrated and preferred embodiment, the seal breaking structure 20 is shown in the form of a plurality of teeth (e.g., blades, cutting blades). In the illustrated and preferred embodiment, the seal breaking structure 20 protrudes upwardly between the mount structures 18 such that they perforate (e.g., tear, break) and/or at least partially remove the frangible seal 32 from the chalk dispensing opening 30 during attachment of the chalk cartridge 14. As an example, and as best shown in FIG. 6D, the chalk dispensing opening and the associated frangible seal 32 are angled such that the seal breaking structure 20 at least partially removes or perforates the frangible seal 32 during attachment of the chalk cartridge 14 to the chalk line housing 12. The partial or full removal and/or perforation of the frangible seal 32 allows the chalk inside the chalk compartment 28 to transfer to the second interior space 36. In the illustrated and preferred embodiment, the chalk dispensing opening 30 of the chalk compartment 28 is aligned with the top of the second interior space 36 when the chalk cartridge 14 is attached to the chalk line housing 12 such that the second interior space 36 is open to the chalk compartment 28. In the illustrated and preferred embodiment, the removal and/or perforation of the frangible seal 32 by the seal breaking structure 20, along with the alignment of the chalk dispensing opening 30 with the second interior space 36 during attachment of the chalk cartridge 14 to the chalk line housing 12 allows a user of the chalk line reel system 10 to quickly and easily refill (e.g., replace, change) the chalk within the chalk line housing 12. In the illustrated and preferred embodiment, this attachment process allows a new chalk cartridge 14 to be installed without risk of spilling chalk before attachment to the chalk line housing 12 (e.g., the frangible seal 32 seals the chalk dispensing opening 30 until it is perforated and/or removed by the seal breaking structure 20 as the chalk cartridge 14 engages the mount structure 18 of the chalk line housing 12).

While other chalk line reel systems may be used, the chalk line reel system 10 of the illustrated and preferred embodiment, is an automatic rewinding chalk line. The chalk line housing 12 includes a spring to drive the reel 22 to rewind the chalk line 24. In the illustrated and preferred embodiment, the reel 22 is connected to or includes a gear system (e.g., gear or number of gears) connected to the spring. The gear system, for example, can reduce the number of windings of the spring that are necessary to rewind the chalk line 24. In the illustrated and preferred embodiment, the gear system, for example, provides a 4:1 reduction in the number of spring windings necessary to rewind the chalk line 24. In some examples, the increased speed of retraction from the gear system 51 may increase the chance of binding of the chalk line 24 during retraction. In the illustrated and preferred example, the posts 42 (e.g., the wrapping of the chalk line 24 around the posts 42 between the grommet 38 and the first passage 39, as best shown in FIG. 3) improve the resistance of the reel 22 to binding of the chalk line 24 during retraction, for example, by increasing tension on the chalk line 24. In the illustrated and preferred embodiment, the chalk line housing 12 includes an actuated reel/stop button 50. The button 50 is shown in the form of a pivoting button and is configured to pivot between a forward position (e.g., reel position) or a rearward position (e.g., stop position). In the illustrated and preferred embodiment, the button 50 is biased towards the rearward position (e.g., stop position) by a spring to at least partially engage the reel 22 in the stop position. In some examples, the engagement of the button 50 allows the reel 22 to rotate via a ratcheting mechanism. In the illustrated and preferred embodiment, the button 50 biased towards the rearward position fully engages the reel 22 to prevent rotation of the reel 22. Pivoting the button 50 to the forward position (e.g., reel position) disengages the button 50 from reel 22 to allow the reel 22 to freely spin to unwind or rewind the chalk line 24. In the illustrated and preferred example, manually holding the button 50 in the stop position engages the reel 22 to stop rotation of the reel 22 and prevent the winding or unwinding of the chalk line 24 from the reel 22.

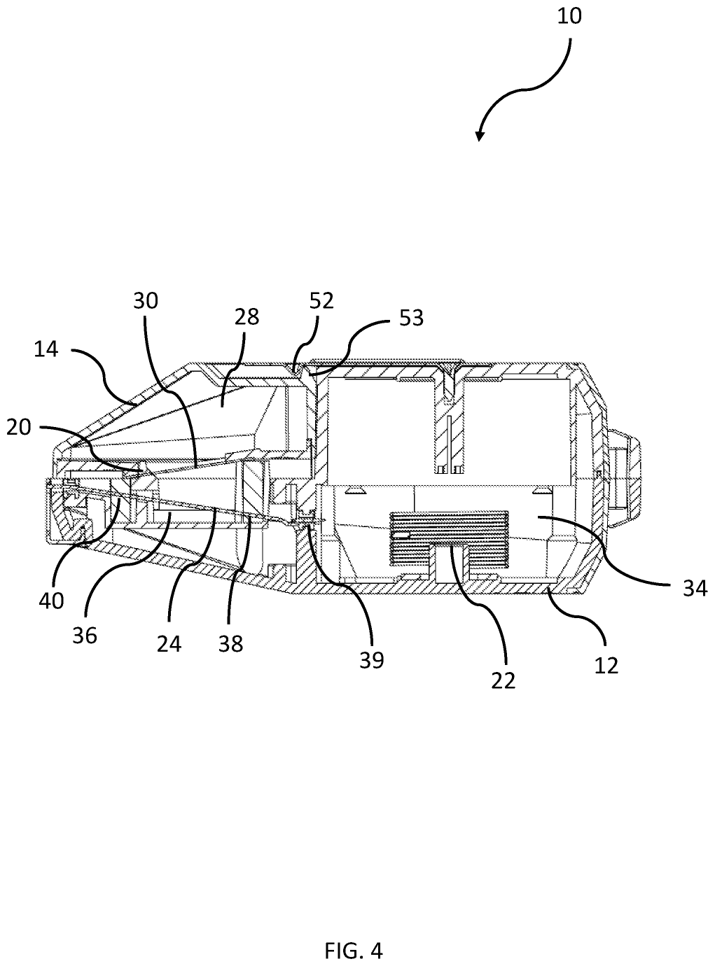

In the illustrated and preferred embodiment, the chalk line housing 12 includes a retention clip 52 to retain the chalk cartridge 14 thereto. The chalk cartridge 14 includes a protruding nub 53 (e.g., lip, catch). As best shown in FIGS. 4 and 6D, the retention clip 52 engages the nub 53 when the chalk cartridge 14 is attached to the chalk line housing 12 to retain the chalk cartridge 14 to the chalk line housing 12. To remove chalk cartridge 14 from the chalk line housing 12, a user may lift up on the retention clip 52 to release the chalk cartridge 14 and allow the user to slide the chalk cartridge 14 away from and disengage from the chalk line housing 12. In the illustrated and preferred embodiment, the chalk cartridge 14 includes a pair of protruding grip surfaces 54, each positioned on an opposite side of the chalk cartridge 14. The grip surfaces 54 may be gripped by the user to aid in removing the chalk cartridge 14 from the chalk line housing 12.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the chalk line reel system 10 are shown in the figures, it should be understood that this disclosure anticipates variations in the specific details of each of the disclosed components and features of the material dispenser and that no limitation to a specific form, configuration, or detail is intended unless expressly and specifically recited in an appended claim.

For example, while specific and preferred forms have been shown for the reel 22 of chalk line reel system 10 with an automatic rewind feature, other forms may be used. For example, the chalk line reel system 10 may be a manual chalk reel having a manually operated crank arm operably connected to the reel 22 to allow a user to manually rotate the reel. In some examples, the reel 22 may be an electronically rewinding reel. While the chalk line reel system 10 has been shown including a gear system 51, in some examples the chalk line reel system 10 may not include a gear system 51. For example, a hand crank, spring, or electric drive may be directly connected to the reel 22 without the gear system 51 or may be connected to the reel 22 through the gear system 51.

As a further example, while seal breaking structure 20 is shown in the form of a plurality of teeth, the a seal breaking structure 20 may include any number of teeth and/or cutting blades or combination of teeth and/or cutting blades. The seal breaking structure 20 may include a single tooth or a single cutting blade. In some examples, the seal breaking structure 20 may include a blunt surface capable of pushing or otherwise removing the frangible seal 32 from the chalk dispensing opening 30.

As another example, while the frangible seal 32 is shown in the form of foil seal, other examples may use other sealing materials or sealing membranes, as are known in the art, such as plastic or paper seals. In some examples, the frangible seal 32 may be manually removed and, for example, may have a pull tab to open. Further, while the frangible seal 32 has been shown as being induction sealed, in some examples the frangible seal 32 may use adhesives or other methods to seal the frangible seal 32 to the chalk dispensing opening 30. In some examples, the chalk cartridge 14 may include a removable cap over the frangible seal 32 to prevent puncturing of the frangible seal 32 prior to installation.

As yet a further example, while the interior space 16 is shown as being divided into the first interior space 34 and the second interior space 36 and divided by the grommet 38 and the first passage 39, in some examples the chalk line housing 12 may not include the grommet 38 and/or the first passage. For example, the interior space 16 may comprise a single opening (e.g., compartment, interior space) within the chalk line housing 12. For example, the reel 22 may be open to the chalk dispensing opening 30 of chalk compartment 28 when the chalk line housing 12 is connected to the chalk cartridge 14. The chalk from the chalk cartridge 14 may be directly deposited into the interior space 16 housing the reel 22.

As another example, while the mount structure 18 is shown in the form of a pair of raised sidewalls with outwardly protruding lips 43, other connection types (e.g., clips) may be used, such as, a single rail, a plurality of rails, or rails having shapes other a protruding lip (e.g., post with a round/spherical top). In some examples, the chalk line housing 12 does not include sidewalls (e.g., rails) and instead or additionally includes guides on the chalk line housing 12 or interlocking geometry that does not include rails.

As another example, while retention clip 52 and protruding nub 53 are shown in the illustrated and preferred embodiment to retain the chalk cartridge 14 to the chalk line housing 12, the locking (e.g., attachment) feature may be provided by a plastic clip, a button release, or a locking feature without a nub.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

What is claimed is:

1. A chalk line reel system comprising:
a chalk cartridge comprising:
a cartridge housing comprising a chalk compartment at least partially filled with chalk and a chalk dispensing opening to the chalk compartment; and
a frangible seal closing the chalk dispensing opening;
a chalk line housing comprising:
an interior space;
a mount structure for releasably mounting the chalk cartridge; and
a seal breaking structure configured to break the frangible seal to allow chalk to be dispensed from the chalk compartment into the interior space with the chalk cartridge engaged in the mount structure;
a reel mounted to the housing for rotation relative to the housing about a reel axis; and
a chalk line wound around the reel and engageable with chalk contained in the interior space.

2. The chalk line reel system of claim 1, wherein the seal breaking structure partially removes the frangible seal as the chalk cartridge engages the mount structure.

3. The chalk line reel system of claim 1, wherein the seal breaking structure perforates the frangible seal as the chalk cartridge engages the mount structure.

4. The chalk line reel system of claim 1, wherein:
the chalk cartridge further comprises mount receiving structure, defining a sliding axis, configured to slidably engage the mount structure, along the sliding axis, to releasably mount the chalk cartridge; and
the seal breaking structure perforates the frangible seal as the mount receiving structure slidably engages the mount structure.

5. The chalk line reel system of claim 4, wherein the frangible seal and the chalk dispensing opening form an acute angle relative to the sliding axis.

6. The chalk line reel system of claim 1, wherein the seal breaking structure comprises a plurality of teeth.

7. The chalk line reel system of claim 1, wherein the seal breaking structure comprises a cutting blade.

8. The chalk line reel system of claim 1, further comprising a spring operably connected to a gear system to rotate the reel.

9. The chalk line reel system of claim 8, wherein the frangible seal comprises a foil portion induction sealed to an edge of the chalk dispensing opening.

10. The chalk line reel system of claim 1, wherein:
the interior space comprises a first interior space and a second interior space;
the reel is mounted to the housing in the first interior space;
the chalk is contained in the second interior space; and
the chalk line housing further comprises a fibrous material, between the first interior space and the second interior space, limiting passage of chalk between the first interior space and the second interior space.

11. A chalk line reel comprising:
a chalk line housing comprising:
an interior space;
a mount structure for releasably mounting a chalk cartridge; and
a seal breaking structure configured to break a frangible sea of the chalk cartridge to allow chalk to be dispensed from the chalk cartridge into the interior space with the chalk cartridge engaged in the mount structure;
a reel mounted to the housing for rotation relative to the housing about a reel axis; and
a chalk line wound around the reel and engageable with chalk contained in the interior space.

12. The chalk line reel of claim 11, wherein the seal breaking structure is configured to partially remove a frangible seal of the chalk cartridge as the chalk cartridge engages the mount structure.

13. The chalk line reel of claim 11, wherein the seal breaking structure is configured to perforate a frangible seal of the chalk cartridge as the chalk cartridge engages the mount structure.

14. The chalk line reel of claim 11, wherein the seal breaking structure comprises a plurality of teeth.

15. The chalk line reel of claim 11, wherein the seal breaking structure comprises a cutting blade.

16. The chalk line reel of claim 11, further comprising a spring operably connected to a gear system to rotate the reel.

17. The chalk line reel system of claim 11, wherein:
the interior space comprises a first interior space and a second interior space;
the reel is mounted to the housing in the first interior space;
the chalk is contained in the second interior space; and
the chalk line housing further comprises a fibrous material, between the first interior space and the second interior space, limiting passage of chalk between the first interior space and the second interior space.

18. A chalk cartridge for use with a chalk line reel, the chalk cartridge comprising:
a cartridge housing comprising a chalk compartment at least partially filled with chalk and a chalk dispensing opening;
mount receiving structure, defining a sliding axis, configured to slidably engage the chalk line reel, along the sliding axis, to releasably mount the chalk cartridge to the chalk line reel; and
a frangible seal closing the chalk dispensing opening;
wherein the frangible seal and the chalk dispensing opening form an acute angle relative to the sliding axis.

19. The chalk cartridge of claim 18, wherein the chalk cartridge further comprises mount receiving structure, defining a sliding axis, to releasably mount the chalk cartridge to the chalk line reel.

20. The chalk cartridge of claim 19, wherein the frangible seal and the chalk dispensing opening form an acute angle relative to the sliding axis.
